(19) United States
(12) Patent Application Publication
(10) Pub. No.: US 2021/0264372 A1
(43) Pub. Date: Aug. 26, 2021

(54) AUTOMATED HUMAN RESOURCES MANAGEMENT AND ENGAGEMENT SYSTEM AND METHOD

(71) Applicant: IMI Material Handling Logistics Inc., Ottawa (CA)

(72) Inventors: Rudi ASSEER, Ontario (CA); David KER, Ontario (CA); Diana CUTTELL, Ontario (CA)

(73) Assignee: IMI Material Handling Logistics Inc., Ottawa, ON (CA)

(21) Appl. No.: 17/253,736

(22) PCT Filed: Jul. 4, 2019
(86) PCT No.: PCT/CA2019/050919

§ 371 Date: Dec. 18, 2020

Related U.S. Application Data
(60) Provisional application No. 62/693,933, filed on Jul. 4, 2018.

(51) Int. Cl. G06Q 10/10; G06Q 10/06; H04L 12/58; G06N 20/00

(52) U.S. Cl. CPC G06Q 10/1053; G06Q 10/063112; G06N 20/00; H04L 51/36; G06Q 10/0633

(57) ABSTRACT

The present invention provides a system for automated human resources management and real-time communication comprising a unified communications layer integrated with an automation engine and a tools layer. The unified communications layer unifies multiple communication channels. The automation engine comprising real-time predictive analytics and artificial intelligence to manage communications and/or trigger tool layer in response to the communications. The tools layer comprising one or more service(s) and/or data.

### FIELD

The present invention pertains to the field of human resources management, and in particular to a system and method for automated human resources management and real-time communication.

### BACKGROUND

The success of an organization relies heavily on hiring and retaining employees having the right skill sets. Significant resources, including time and money, can be spent by an organization on matters relating to human resources. Moreover, in competitive human resources landscapes companies must react rapidly. Digital transformation and automation of the processes to hire and retain employees will allow these processes to be more productive, cost effective and will enable faster candidate and employee engagement with results coming out real-time.

Human resources software systems which automate the recruiting process are known in the art. For example, US2009/0132313 teaches a database to store descriptions of jobs each of which is defined by competencies; a database to store descriptions of candidates each of which is defined by competencies; a processor operable to automatically report a ranked match between a single job and many candidates based on matching competencies, or to automatically report a ranked match between a single candidate and many jobs based on matching competencies; and a user interface to display the resulting report. U.S. Pat. No. 8,086,558 teaches a system and method for testing and/or evaluating employees or potential employees based on responses to a plurality of questions. U.S. Pat. No. 8,156,051 teaches an employment recruiting system which automates services related to employment recruiting. In particular, U.S. Pat. No. 8,156,051 automatically searches a data base containing candidate resumes in response to a search parameter associated with a position advertisement and automatically contacts screened candidates. U.S. Pat. No. 8,112,365 teaches an online, web-based environment that allows employers to create job descriptions for posting on an internet-based job search service in communication with a web-based environment and allows for online recruitment and review of hiring candidates. In addition, systems such as Mya, OnboardIQ and TalentGenie utilizes artificial intelligence to automate the pre-hiring process.

The human resources process can be summarized into three phases: pre-hiring (screening and rating or ranking of candidates), hiring (onboarding, document signing and background check) and post-hiring (engagement and rating). There is a need in the art for a system which can work across all three phases of the human resources process.

There is a need in the art for systems that integrate relationship management functionality with a real-time conversation layer for human resources management.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an automated human resources management system and method. In accordance with an aspect of the present invention, there is provided a system for automated human resources management and real-time communication comprising a unified communications layer integrated with an automation engine and a tools layer; said unified communications layer unifying multiple communication channels in real-time; said automation engine comprising real-time predictive analytics and artificial intelligence to manage communications and/or trigger tool layer in response to said communications; and said tools layer comprising one or more service(s) and/or data.

In accordance with another aspect of the present invention, there is provided a method of automated human resources management, said method comprising: communicating, by a server computing device, a position for employment to candidates; receiving, by said server computing device, candidate applications for said position; processing, by said server computing device, candidate applications; selecting, by said server computing device candidates for automated interview based on pre-determined criteria; interviewing, by said server computing device, selected candidates by asking questions based on the specific competencies required for said position; and ranking said interviewed candidates based on candidate responses to queries. The method may further comprise communicating, by said server computing device, an offer of employment to highest ranked candidate. The method may further comprise accepting, by said server computing device, an acceptance to the offer of employee; and performing, by said server computing device, one or more onboarding, document signing, background check of successful candidates. Optionally, the method also comprises performing, by the server computing device, human resources services selected from the group consisting of payroll, personnel administration, time management, employee engagement and employee rating.

In accordance with another aspect of the present invention, there is provided a computer implemented method for filling a job vacancy, the method comprises receiving a request for staffing for a job, wherein the request includes job requirements; screening job candidates for compliance with the job requirements; automatically identifying candidates that are compliant with the job requirements; optionally forwarding an automated interview request; forwarding a job offer to a skillful candidate; and closing the job post once the job is accepted by a candidate.

In accordance with another aspect of the present invention, there is provided a computer implemented method of creating a recruitment database, said method comprising: receiving, by a server computing device, contact information of one or more candidates, wherein optionally said contact information is obtained from information inputted in an online recruitment form; communicating, by a server computing device, a series of questions to said one or more candidates; analyzing responses to said series of questions to create a profile of each of the one or more candidates; and storing each of said profiles in a database.

In accordance with another aspect of the present invention, there is provided a computer implemented method of employee onboarding, said method comprising: communicating, by a server computing device, information on onboarding process to a new employee and automatically responding to queries from said new employee or automatically forwarding queries to human resources professional; automatically triggering, by said server computing device, account creation for said new employees; and determining job satisfaction of said new employee and automatically notifying human resources if said job satisfaction is below a pre-determined level.

In accordance with another aspect of the present invention, there is provided a computer implemented method of automatically scheduling of a hiring event, comprising: receiving by a server computing device, a selection of dates and times from the hiring staff during which to schedule the hiring event; communicating, by said server computing device, with the candidates and scheduling the hiring event; producing a calendar of the scheduled hiring event; and automatically sending reminders regarding said scheduled hiring event.

### BRIEF DESCRIPTION OF THE FIGURES

These and other features of the invention will become more apparent in the following detailed description in which reference is made to the appended drawings.

FIG. 1 provides an overlapping sub-systems diagram of the system of an embodiment of the present invention. In this embodiment the sub-systems include a Conversation User Interface (UI) (A), a Conversation Layer (UC) (B), an AI component comprising a BOT+Recipe+Workflow engine (C) and a Human Resource Information System or Recruiting/Staffing Software (D). The system of this embodiment provides the combination of these elements to create a platform for workforce's engagement automation. In this embodiment, the human resource information system manages candidates, employees, employers, jobs data, job board, time sheet, payroll, and many more function for human resources. The Conversation Layer, comprises a communication stack unifying the communication across multi channels. The Conversation User Interface comprises a user interface implementation that enables the collaboration between recruiters, HR managers, candidates and employees. The AI component automates the engagement between all parties involved in the platform.

FIG. 2 provides an illustration of the phases of the human resources process and activities of the system of an embodiment of the invention at each phase. In human resources, the people management process can be summarized into P1 (Pre-Hiring), P2 (Hiring or On-boarding), P3 (Post-Hiring). P1 comprises of all the steps necessary to attract candidates through a job board, accepting job applications, performing pre-screening and screening activities and so on. P2 comprises of the selection of candidate, onboarding a candidate, signing documents, signing the job acceptance, performing background check, performing reference checks, etc. P3 (Post-Hiring) phase comprises of the managing candidates who are now employees of the organization. This step involves all process to management current talents, from time sheet management, payroll, pulse of the companies and so one.

FIG. 3 illustrates components of the system include databases, artificial intelligence, communication platforms and workflow engines and the systems engagement with security/privacy protocols and dynamic data management or tagging system.

FIG. 4 provides an illustration of the various channels of engagement, various services and data available with the staffing system of an embodiment of the present invention. The system of the present invention comprises of a service layer, a data layer and the channels layers through which the communications exchanges occurs. The data layer may comprise relational databases for data including but not limited to job data, candidate profiles, employer profiles, location information, client information and IOT data. The services layer comprises of the services offered by system. Services may include but is not limited to a conversation engine, job boarding portal, customer portal, candidate portals, web hook or web services, bot recipe engine, rating system.

FIG. 5 provides an illustration of the conversation layer and tools layer of the staffing system of an embodiment of the present invention. FIG. 5 illustrates how the system in the middle of the conversations and is responsible to provide access to the tools/services layers at the bottom.

FIG. 6 provides an illustration of the conversation layer, unified communication layer and tools layer of the staffing system of an embodiment of the present invention and illustrates how the system abstracts the communication layer to create a unified communication layer facilitate the conversations between parties involved in a HR platform. The Unified Communication Layer is an abstraction that is similar to the unified communication in the telecom industry, however, in certain embodiments, an AI powered digital assistant is inserted in-between parties to facilitate and automate some of the communications between parties.

FIG. 7 illustrates engagement by the staffing system of an embodiment of the present invention. Within this system, all conversations between candidates and recruiter pass through system. This has the benefits that system can augment the recruiter's responsiveness, even in their absence. The system becomes the recruiter assistant in this scenario.

FIG. 8A depicts the user interface of an embodiment of the present invention accessible to the administrator, HR Manager and Recruiters. This user interface provides the means for these personnel to program the BOT Engine to perform a certain automated process (called Recipe). Through the Recipe, the HR personnel can configure the logic that will be executed by system for outbound engagement or inbound engagement. FIG. 8B illustrates a screen of the user interface for a recruiter or HR Manager to view the list of Bot Recipes created, with method to manage the recipes.

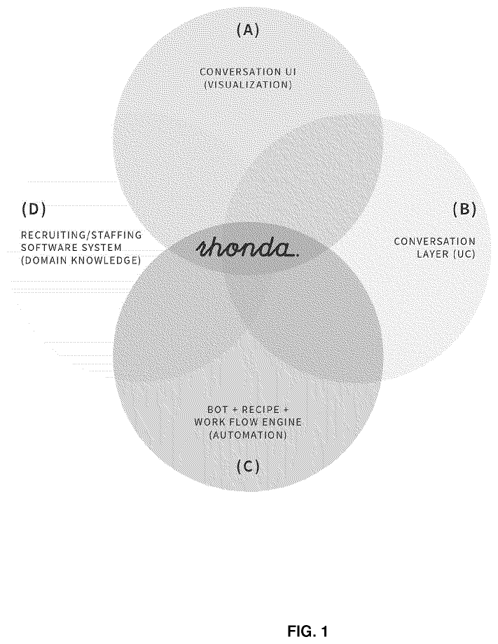

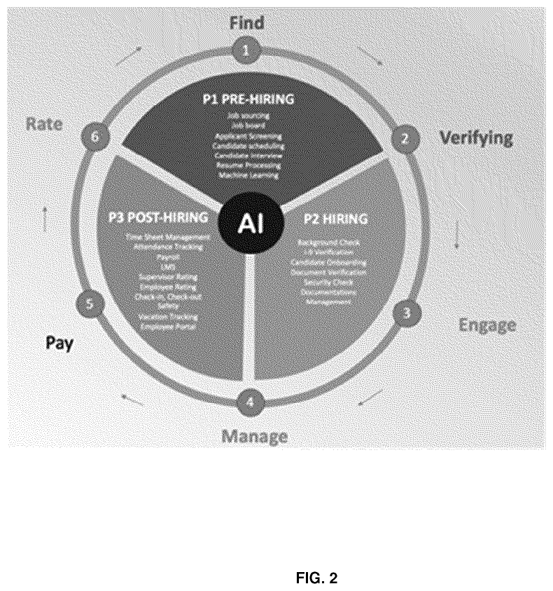

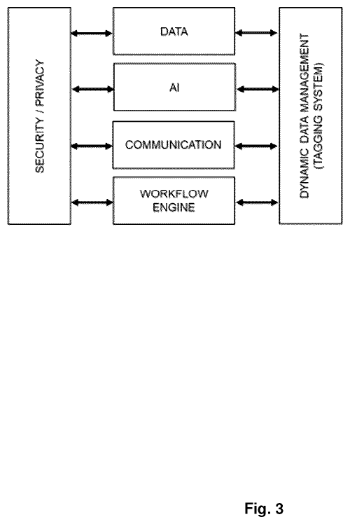

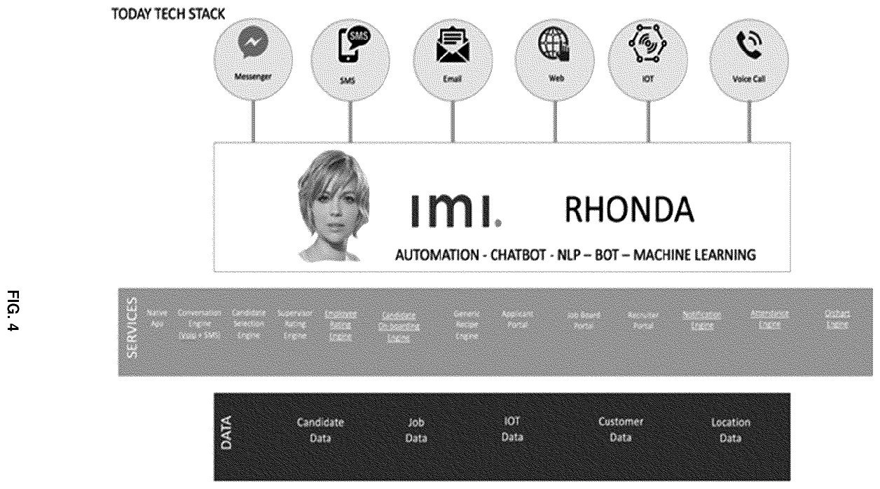

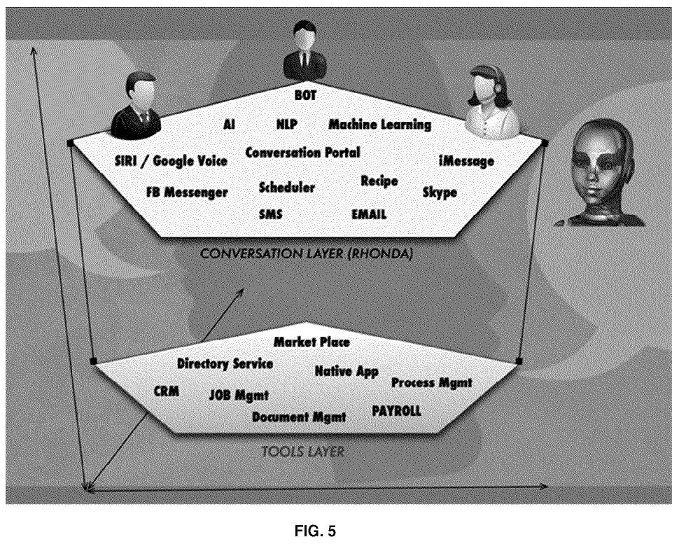

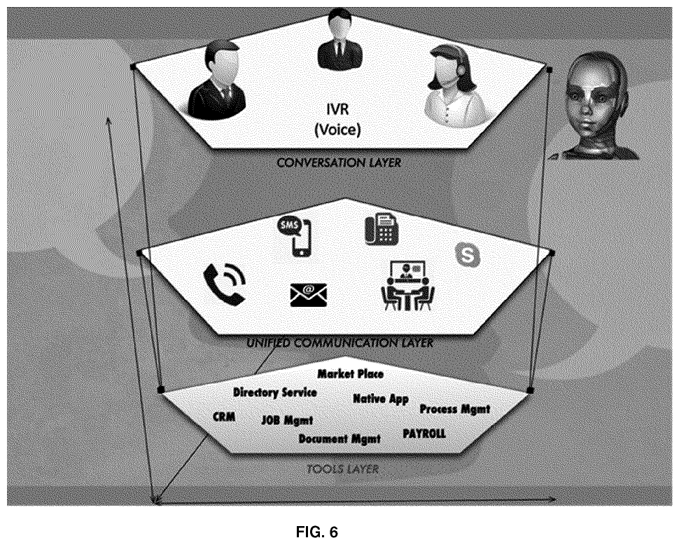

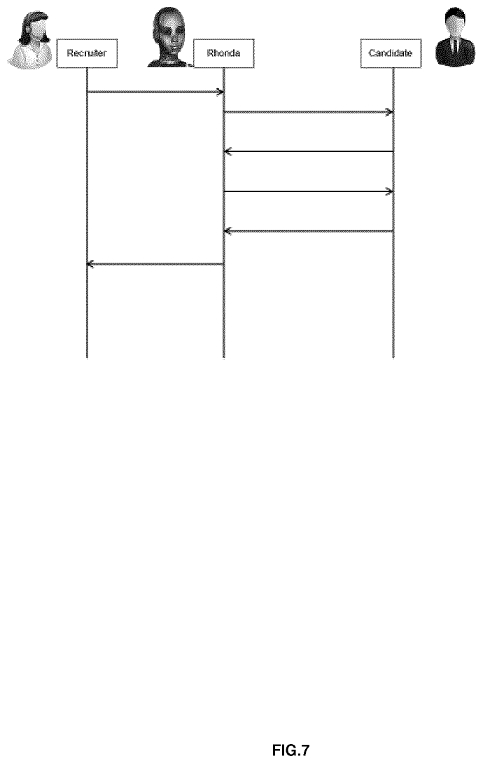

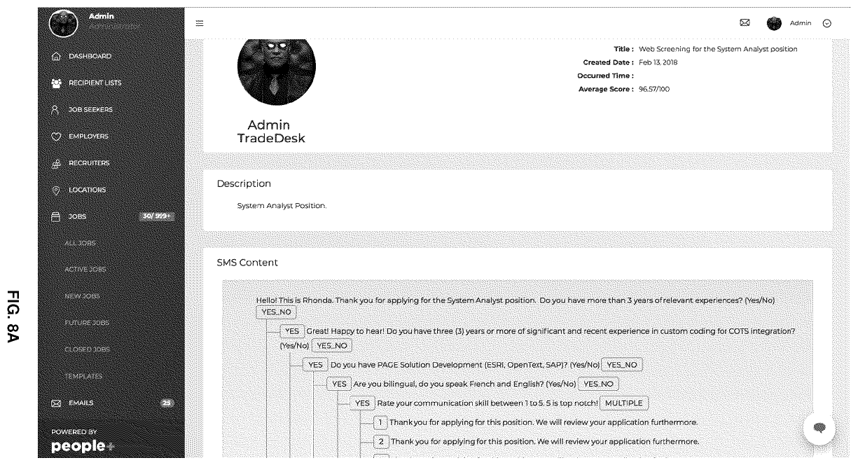

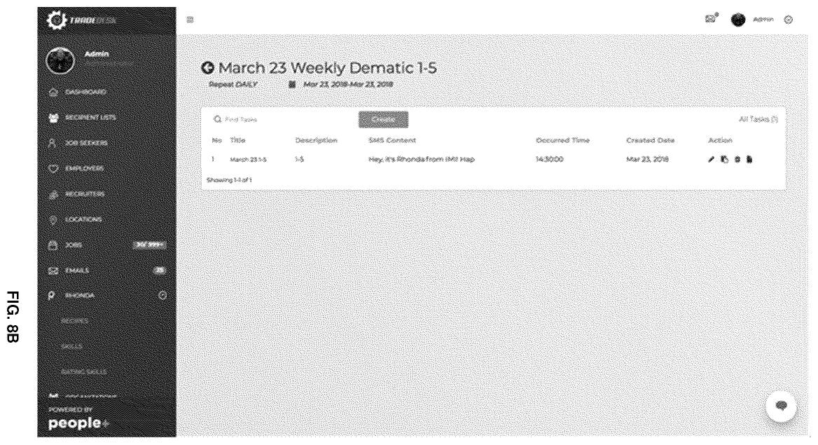

### DETAILED DESCRIPTION

The present invention provides a system and method for human resources (HR) management. The method and system of the present invention automates one or more services from one or more of the phases of the human resources process. In certain embodiments, the method and system of the present invention automates one or more of services from each of the phases of the human resources process. In certain embodiments, the system and method of the present invention screens candidates through fully automated interviews. In specific embodiments, the present invention provides a talent engagement system; automated talent conversational system, automated candidate screening system, automated candidate onboarding system and an automated talent rating system.

In specific embodiments, the system of the present invention automatically processes applications and/or reviews resumes of candidates, automatically communicates with candidates, interviews and ranks candidates by asking specific questions based on the specific competencies required. After hiring, in certain embodiments, the system acts as an employment management tool. For example, the system may be used to determine employee moral by sending automated communications, including but not limited to surveys, to employees. In certain embodiments, the communications are in the form of email, text or phone calls. In certain embodiments, these communications are two-way communications. In certain embodiments, the communications are in a conversation format with multiple back and forth. In certain embodiments the communications are in real time. In certain embodiments, text messaging, instant messaging using messaging apps are used for real-time communication with a candidate or employee.

The system may be server-based or a cloud-based system. The system of the present invention is capable of executing a conversation flow for one to thousands of users at the same time. Through the utilization of automation and artificial intelligence human involvement is reduced or minimized which cost effectively enables the engagement with one or thousands of candidates at the same time. The system and method of the present invention also allows for the collection and processing of data in real-time. This data may be used by the system and the method of the invention to improve the human resources process.

The system and method for human resources management may be used in various industries and, in certain embodiments, can be customised to meet industry specific needs. For example, different industries may require different types of assessment of job candidates and current employees. Accordingly, the system of the present invention allows for different types of assessment including, for example, assessment of professional certification or accreditation, assessment of years of experience, technical experience, language skills (i.e. bilingual) etc.

The system of the present invention comprises a unified communications layer integrated with an automation engine and a tools layer.

As used herein, unified communications, refers to a framework for integrating multiple communication channels, including real-time (for example instant messaging) and non-real-time (for example email). Exemplary communication channels include but are not limited to Voice over Internet Protocol (VoIP), short message service (SMS), instant messaging (IM), email and web interface. Various IM applications are known in the art and include but are not limited to Discord, eBuddy XMS, Facebook Messenger, iMessage, Kik Messenger, Line, Skype, Snapchat, Telegram, WeChat, WhatsApp, BlackBerry Messenger.

In certain embodiments, the unified communications layer integrates multiple communication channels in real-time. In specific embodiments, the unified communications layer integrates VoIP and SMS.

Optionally, the communications layer further comprises a conversation user interface. The conversation user interface may be website based or application (app) based. The conversation user interface may be in the form of a voice-user interface or a chatbot. In specific embodiments, the chatbot utilizes SMS or a messaging applications (apps). In specific embodiments, the system utilizes a connectionless SMS app. In alternative embodiments, the system maintains a connection with the message recipient. Exemplary apps that maintain a connection include Skype. In other embodiments, the chatbot is website based.

The automation engine comprises real-time predictive analytics, including but not limited to conversational analytics, and artificial intelligence, including but not limited to machine learning, natural language processing, deep learning or combinations thereof, to manage communications and/or trigger the tool layer in response to the communications.

Communications may be uni-directional, bi-directional or multi-directional. Communications may be to an individual, multiple individuals or machine to machine. In certain embodiments, the system of the present invention can send communications in one or more languages. In certain embodiments, the system of the present invention can send communications to multiple individuals in the language preference of the recipient. In certain embodiments, the system of the present invention, can translate incoming communications into the language of the recipient.

In certain embodiments, all communications or a subset of communications go through a centralized system, providing centralized access and views of all engagement between all HR stakeholders. In certain embodiments, the system of the present invention generates mass SMS messages for transmission to many remote users on mobile devices. In certain embodiments, voice communications go through WebRTC.

In certain embodiments, the system sends communications in response to a particular action and/or trigger, as part of a workflow or at regularly scheduled intervals. Regular scheduled communications can be sent at any time interval including but not limited to hourly, daily, weekly, monthly or yearly.

In certain embodiments, the system of the present invention utilizes a cloud communication platform, such as Twilio, for real-time communications. In specific embodiments, the system of the present invention sends mass communications through a single phone number. For example, a Twilio framework may be used to send mass communications through a single phone number. In certain embodiments, mass communications are sent through multiple phone numbers.

Optionally, the system of the present invention routes messages sent to the system. For example, subsequent replies to the previously sent messages may be routed to, for example, a specific administrator. Routing may be by one of the following mechanisms: a) utilizing a unique phone number for each unique administrator which allows for mapping of replies to the specific administrator who sent the original SMS message; b) creating a separate session for each SMS message recipient, for each message; and c) tagging each message with a tag unique to the administrator which sent the message.

In certain embodiments, a message broker is utilized to manage message queue and/or route messages to one or more destinations. Exemplary message brokers are known in the art and include for example RabbitMQ.

In certain embodiments, virtual communication sessions are created and maintained for a minimum period of time. In certain embodiments, the session is maintained for at least one hour, at least 4 hours, at least 12 hours or at least 24 hours. In specific embodiments, the session is maintained for 24 hours. In specific embodiments, the virtual communication sessions are extended by sending or receiving a new communication, such as a SMS message.

In certain embodiments, the system automatically triggers a new communication, such as a new SMS message at pre-determined intervals. In specific embodiments, the system triggers a new SMS message every 4 hours.

The system may be configured to perform specific tasks, including sending out communications and/or initiating a workflow on a schedule or in response to a particular action/trigger.

In certain embodiments, one or more actions, including but not limited to sending a communication or notification and/or one or more workflows are initiated in response to a particular action or trigger. Such actions or triggers may include communications such as an email or message or a failure to respond to a communication, completion of a task or failure to complete a task within a pre-set period of time. For example, the system may communicate with an employee to determine job satisfaction and may send a notification to human resources or a manager if job satisfaction is low or below a specified level. As a second example, the system may send a notification to human resources when the system receives an indication that an employee is absent from a pre-scheduled job site.

In certain embodiments, the system comprises a workflow engine for initiating one or more previously generated workflows or generating one or more workflows in response to pre-defined rules and/or machine learned rules. Workflows may be fully automated or partially automated. For example, in certain embodiments, the system performs automatic pre-screening interview once a candidate applies for a job through a job portal, auto select qualified candidates into a shortlist such the recruiter only has to deal with a minimum number of candidates.

In certain embodiments, the workflow engine allows users to run an automated workflow with zero coding. In such embodiments, the workflow engine utilizes pre-coded scripts. Optionally, an alert/notification or tag is issued at each stage of the one or more workflows. For example, a candidate file may be tagged with an indication that the candidate has completed an automated interview once the automated interview has been completed. In addition to or as an alternative, a notification may be sent to the HR professional overseeing the screening of candidates once a candidate has completed the automated interview.

In certain embodiments, the workflow engine automates one or more human resources processes related to pre-hiring, hiring and/or post-hiring. Human resources services can be organized into services related to the pre-hiring phase, hiring phase and/or post-hiring phase. Employees can be paid or non-paid. Services related to the pre-hiring phase (phase 1) include but are not limited to screening and rating or ranking of candidates; services related to the hiring phase (phase 2) include but are not limited to onboarding, document signing, background check of successful candidates; and services related to the post-hiring phase (phase 3) include but is not limited to payroll, personnel administration, time management, employee engagement and rating.

Exemplary workflows include workflows related to candidate screening, onboarding, employee engagement and/or management. The workflows may be fully automated or partially automated. A specific example of a workflow includes a workflow for job assignment and verification. Such a workflow may be useful in situations where multiple temporary employees are required.

A non-limiting example of a workflow for job assignment and verification includes the following steps:

1. System receives a request for staffing for a job.

The request includes one or more of the following: job requirements (including for example one or more of the following: candidate requirements, number of positions available, length of job and compensation rate). In certain embodiments, the request is made directly by the employer through a user interface or via an email or instant message. In alternative embodiments, a third party such as a recruiter makes the request on the employer's behalf through a user interface or via an email or instant message.

2. Candidates meeting the job requirements are selected.

In certain embodiments, a job post is posted to an external job board. The system may create a job post and submit the job post to an external job board. In the alternative, the system notifies a recruitment professional who either creates a job post for posting and/or posts a job post. Optionally, the system selects the recruitment professional based on their skill matrix and/or workload. Candidates applying to the posting are then screened for compliance with the job requirements. The system may automatically screen the candidates for compliance with job requirements and/or conducts automated interviews. In certain embodiments, the system conducts an automated pre-screening interview by asking the candidates questions regarding specific criteria. The responses may be used to rank candidates and/or include/exclude candidates for consideration.

Alternatively, a recruitment professional conducts one or more of the steps of the screening process and the system manages each stage of the process. For example, by providing check lists to the recruitment professional which must be completed prior to moving to the next stage of the workflow. Optionally, the system sends a notification and/or tags a candidate's file at the completion of each stage of the workflow. Optionally, the system creates a database of candidates who have completed pre-screening. The database may include but is not limited to details with respect candidate's skill set, education, screening details such as background check, finger prints on file etc.

In certain embodiments, the system automatically screens a database of candidates to identify candidates that meet job requirements. Optionally, the system ranks the candidates.

3. System sends an offer of employment to candidate(s) meeting the requirements for the posted job and the offer includes a request for response to the offer of employment. Alternatively, the system sends a listing of candidates meeting the requirements (optionally ranked) to a recruitment professional. In certain embodiments, if a response is not received by a pre-determined deadline, the system sends a follow-up notification or notifies a recruitment/human resources professional that follow up is required.

4. System receives responses and initiates actions depending on response. For example, if the candidate refuses the job offer, the system may send a follow up or instruct a HR professional to follow up regarding the refusal and to determine if the candidate is available for other employment. If the candidate accepts the job offer, system optionally sends one or more reminder(s) regarding the job and requests that the candidate send confirmation once the job has started. Optionally, if no confirmation is received by a pre-determined deadline, the system sends a follow-up notification or notifies a recruitment/human resources professional that follow up is required. Optionally, the system initiates any required workflows for onboarding, including initiating a payroll workflow.

Optionally, the system updates one or more databases in the tools layer. For example, once the candidate has started a two week job, the system updates candidate profile database to indicate that the candidate is on a particular job for two weeks.

Optionally, the workflow is repeated until all positions are filled. Optionally, if there are insufficient candidates or all positions are not filled by a pre-determined deadline, a notification is sent to a HR professional for follow up.

The workflow engine interacts with one or more components of the tools layer to automate one or more human resources processes.

In certain embodiments, the tools layer comprises one or more engines to automate one or more service(s) related to pre-hiring, hiring and/or post-hiring. In certain embodiments, the tools layer comprises one or more engines to automate one or more service(s) for human resources management selected from the group consisting of candidate selection engine, candidate competency assessment engine, booking system, resume assessment engine, employee rating engine, supervisor rating engine, attendance engine, generic recipe engine, applicant portal, job board portal, recruiter portal and combinations thereof.

In certain embodiments, the tools layer comprises one or more databases. The data which may be utilized by the system and method of the present invention may include but is not limited to candidate profiles data, job profiles data, competency assessment profiles, customer data, vendor data, location data, or a combination thereof. In certain embodiments, the system utilizes third party data. As a non-limiting example, third party data could include weather or traffic data which could be used to predict employee absences or likelihood that an employee will be absent.

In certain embodiments the system can communicate with third party system through a machine-to-machine communication protocol to read data with respect to positioning, system detections, etc that enables the system to trigger some human engagements based on specific business rules. The machine-to-machine communication can use the standardized Web Services method to exchange data between the subsystems.

Non-limiting examples of uses of the system are detailed below.

In certain embodiments, the system of the present invention acts as a recruiter. A non-limiting illustrative example of the system acting as a recruiter is detailed below. Candidates complete a form on the employer website or a third party (such as a recruitment organization) website. The form may be tailored to a specific position or may be a general recruitment form. The form may include a variety of questions types including fill-in sections, dichotomous questions (i.e. yes/no), multiple choice and scaled. In certain embodiments, the form allows for the attachment of one or more digital files such as an electronic copy of a resume. In specific embodiments, the online form only includes basic information and preferences (such as language preference or communication method preference). The system sends one or more communications to the candidate which pose one or more questions. The system analyzes the collected information to create a profile of the candidate in a database (e.g. based on interest and education, a recruit might be categorized as “engineering and science support” as opposed to “purchasing and supply”.). The created database may be used to fill an available position or stored for future use. If a position is available that the candidate in which the candidate meets the required criteria, the system and/or human resources professional will proceed the next steps in the process, which may include presenting an offer of employment to the candidate and negotiating its details with the candidate and onboarding for candidates that accept the position. Optionally, for candidates in the database for future positions, the system sends follow-up communications to candidates in the database at a regular intervals (e.g. every 3 months) to confirm continued interest in employment and/or update information and updates the profile of candidates based on responses. Optionally, the system can produce reports, automatically or in response to user input, from information in the database and/or the recruiting process. Optionally, the system automatically reviews the database to ensure accuracy of information and/or ensure that there are no duplicate profiles.

In certain embodiments, the system of the present invention assists or conducts post-hiring activities required to onboard new employee or students. For example, the system can make a series of communications with the new employees and students which will share information and documents and take appropriate action upon receiving a response. Optionally, the system can poll all of the new employees and students to determine their satisfaction after a pre-determined amount of time (such as after their first week). The results of the poll may be stored in the database for action by onboarding staff and/or the system takes action in response to the results. For example the system may send a notification to human resources or onboarding staff if satisfaction is below a pre-determined level. In certain embodiments, the system of the present invention performs one or more of the following onboarding activities:
Makes first contact and provides information on onboarding process, answers questions on what to expect and to guide employees through post-hiring activities.
Triggers various groups responsible for account creation, e.g. an email account, to ensure the employee is properly equipped and functional on first day on the job. Alternatively, the system automatically creates accounts for new employees
Sends new employees all departmental specific information such as code of ethics, policies, health and safety, etc.
Informs new employees and students of all mandatory training.
Inform new employees of the obligation to develop a personal learning plan.
Remind new employee or student that they should identify a buddy during their first week. If buddy not identified, they should consult their manager.
Informs all new employees of existing support networks, the Meet and Greet etc.

In certain embodiments, the system acts as a virtual assistant and automates the scheduling of a hiring event. The system will receive a selection of dates and times from the hiring staff during which to schedule the hiring event. The system will then communicate with the candidates and schedule their event based on their preferences. The system automatically coordinates all hiring events to ensure that there are no scheduling conflicts. The system then produces a calendar of the scheduled event via its admin dashboard and by a downloaded report. The system sends reminders to both candidates and hiring staff. Optionally, the system will request a confirmation and if it does not receive confirmation, or receive a request for a change to the time of the event, it will take appropriate action, e.g. notify the administrator.

We claim:

1. A system for automated human resources management and real-time communication comprising a unified communications layer integrated with an automation engine and a tools layer;
said unified communications layer unifying multiple communication channels;
said automation engine comprising real-time predictive analytics and artificial intelligence to manage communications and/or trigger tool layer in response to said communications; and
said tools layer comprising one or more service(s) and/or data.

2. The system of claim 1, wherein said real-time communications layer further comprises a conversation user interface.

3. The system of claim 1, wherein said communication channels are selected from the group consisting of VOIP; SMS; instant messaging (IM), optionally selected from the group consisting of Discord, eBuddy XMS, Facebook Messenger, iMessage, Kik Messenger, Line, Skype, Snapchat, Telegram, WeChat, WhatsApp, BlackBerry Messenger; email; web interface and combinations thereof.

4. The system of claim 1, further comprising a workflow engine for initiating one or more previously generated workflows or generating one or more workflows in response to pre-defined rules or machine learned rules.

5. The system of claim 4, wherein an alert or tag is issued at each stage of the one or more workflows.

6. The system of claim 1, wherein said tools layer comprises one or more engines to automate one or more service(s) related to pre-hiring, hiring and/or post-hiring.

7. The system of claim 1, wherein said tools layer comprises one or more engines to automate one or more service(s) related to people management.

8. The system of claim 1, wherein said tools layer comprises one or more engines to automate one or more service(s) for human resources management selected from the group consisting of candidate competency assessment engine, resume assessment engine, employee rating engine, generic recipe engine, applicant portal, job board portal, recruiter portal, onboarding engine, virtual recruitment assistant, employee assistant and combinations thereof.

9. The system of claim 1, wherein said tools layer comprises one or more databases comprising one or more of: candidate data, job data, competency knowledge, IOT data, customer data and location data.

10. A method of automated human resources management, said method comprising:
communicating, by a server computing device, a position for employment to candidates;
receiving, by said server computing device, candidate applications for said position;
processing, by said server computing device, candidate applications;
selecting, by said server computing device, candidates for automated interview based on pre-determined criteria and/or machine learned criteria;
interviewing, by said server computing device, selected candidates by asking questions based on the specific competencies required for said position; and
ranking said interviewed candidates based on candidate responses to queries.

11. The method of claim 10, further comprising:
communicating, by said server computing device, an offer of employment to highest ranked candidate.

12. The method of claim 11, further comprising:
accepting, by said server computing device, an acceptance to the offer of employee; and
performing, by said server computing device, one or more onboarding, document signing, background check of successful candidates.

13. The method of claim 12, further comprising:
performing, by said server computing device, human resources services selected from the group consisting of payroll, personnel administration, time management, employee engagement and employee rating.

14. A computer implemented method for filling a job vacancy, the method comprises receiving a request for staffing for a job, wherein the request includes job requirements;
screening job candidates for compliance with the job requirements;
automatically identifying candidates that are compliant with the job requirements;
optionally forwarding an automated interview request;
forwarding a job offer to a skillful candidate; and
closing the job post once the job is accepted by a candidate.

15. A computer implemented method of creating a recruitment database, said method comprising:
receiving, by a server computing device, contact information of one or more candidates, wherein optionally said contact information is obtained from information inputted in an online recruitment form;
communicating, by a server computing device, a series of questions to said one or more candidates;
analyzing responses to said series of questions to create a profile of each of the one or more candidates; and
storing each of said profiles in a database.

16. A computer implemented method of employee onboarding, said method comprising:
communicating, by a server computing device, information on onboarding process to a new employee and automatically responding to queries from said new employee or automatically forwarding queries to human resources professional;
automatically triggering, by said server computing device, account creation for said new employees; and
determining job satisfaction of said new employee and automatically notifying human resources if said job satisfaction is below a pre-determined level.

17. A computer implemented method of automatically scheduling of a hiring event, comprising
receiving by a server computing device, a selection of dates and times from the hiring staff during which to schedule the hiring event;
communicating, by said server computing device, with the candidates and scheduling the hiring event;
producing a calendar of the scheduled hiring event; and
automatically sending reminders regarding said scheduled hiring event.
